(19) United States
(12) Patent Application Publication
(10) Pub. No.: US 2025/0305415 A1
(43) Pub. Date: Oct. 2, 2025

(54) METHOD FOR BUILDING A TRAFFIC TUNNEL, A CONDUIT SHAFT, OR A PRESSURISED WATER SHAFT BY WAY OF THE TUBBING CONSTRUCTION METHOD

(71) Applicant: SIKA TECHNOLOGY AG, Baar (CH)

(72) Inventor: Götz TINTELNOT, Hamburg (DE)

(73) Assignee: SIKA TECHNOLOGY AG, Baar (CH)

(21) Appl. No.: 18/866,366

(22) PCT Filed: May 19, 2023
(86) PCT No.: PCT/EP2023/063511

§ 371 Date: Nov. 15, 2024

(30) Foreign Application Priority Data
May 19, 2022 (EP) 22174381.8

(51) Int. Cl. E21D 11/08; C04B 14/28; C04B 18/04; C04B 26/02; C04B 111/00; C08K 3/26; C08K 11/00

(52) U.S. Cl. CPC E21D 11/08; C04B 14/28; C04B 18/04; C04B 26/02; C08K 3/26; C08K 11/005; C04B 2111/00663; C08K 2003/265

(57) ABSTRACT

A method for the construction of a trafficway tunnel, a conduit shaft or a pressurized-water shaft by tubbing construction, wherein segment components are assembled in a machine-generated bore in the rock to form a closed lining in the form of a segment tube, and the annular gap between the bore and the outer wall of the segment tube is filled with a composition which includes polymerization-curing reactive resin and filler, where the filler, before or during conveying into the annular gap, is supplied with the polymerization-curing reactive resin, which is mixed with the filler and is dispersed therein, characterized in that the composition is cement-free and the filler includes a non-water-reactive inorganic material which has an average particle size≤500 μm.

The present invention relates to a method for the construction of a trafficway tunnel, a conduit shaft (conduits for electricity, water or gas) or a pressurized-water shaft (motive-water shaft for hydropower plants) by tubbing construction, in which segment components are assembled in a machine-generated bore in the rock or soil to form a closed lining in the form of a segment tube, and the annular gap between the bore and the outer wall of the segment tube is filled with a polymerization-curing reactive resin and filler.

A tunnel-building method of this kind by tubbing construction is known from EP 3 913 186 A1. In the known method, the annular gap between the outer wall of the segment tube and the surrounding rock mass is filled with a mixture of cement as filler and a polymerization-curing reactive resin.

Most tunnel construction guidelines are also based on the use of a one-component cement suspension/mortar or a two-component cement/waterglass combination as a filling material so that it has sufficient load-bearing capacity.

However, large amounts of carbon dioxide (CO₂) are released during cement production. Hydroxide ions are also released during the reaction of the cement with water, and can accumulate in the surrounding soil and in the groundwater. This can lead to an increase in the pH of the groundwater at these points and to a mobilization of the heavy metals contained therein, such as cadmium or arsenic.

An object of the present invention is to provide an improved method for the construction of a trafficway tunnel, a conduit shaft or a pressurized-water shaft by tubbing construction.

The method with the features of claim 1 serves to achieve this object. Advantageous embodiments of the invention are specified in the dependent claims.

According to the invention, a non-water-reactive inorganic material is used as filler, and is supplied, before or during conveying into the annular gap, with the polymerization-curing reactive resin. The reactive resin is mixed with the filler before or during injection into the annular gap and is dispersed therein.

It has now been found, surprisingly, that a non-water-reactive inorganic material which has an average particle size≤500 μm can be used as filler in the method described in EP 3 913 186 A1 and still a sufficient load-bearing capacity of the annular gap filling is achieved. By using the non-water-reactive material with a small particle size as filler, furthermore, a good fluidity of the composition can be achieved, so that the materials can be pumped over a long distance from the tunnel entrance to the site of use and can be used there for filling the annular gap.

Surprisingly, it has also been found that the use of the non-water-reactive inorganic material leads to better workability, while at the same time providing sufficient strength and load-bearing capacity of the composition.

The use of non-water-reactive material also achieves a neutral pH of the filler, thereby avoiding soil contamination through lowering of the pH.

Furthermore, the method of the invention has the advantage that no further chemical admixtures such as flow improvers or modifiers have to be used which can pollute the soil.

The composition further combines a high ductility with sufficient strength, which has the advantage that stresses in the soil can be compensated by the annular gap filling and the latter does not fragment.

The composition used for filling the annular gap in the method of the invention is cement-free, meaning that it contains no cement. Instead, the composition comprises polymerization-curing reactive resin and filler, the filler comprising a non-water-reactive inorganic material which has an average particle size≤500 μm.

Within the scope of this invention, a non-water-reactive inorganic material is an inorganic material which does not undergo reactions with water at room temperature, or does so only in a negligible amount. It is therefore inert toward water. Preferably, the material is barely or only poorly soluble in water and forms a suspension with it.

In an advantageous embodiment, the non-water-reactive inorganic material has an average particle size of 0.5 to 500 μm, such as 0.5 to 300 μm.

In an advantageous embodiment, the non-water-reactive inorganic material has an average particle size≤200 μm, more particularly≤100 μm. The non-water-reactive inorganic material may preferably have an average particle size of 5 to 100 μm. The particle size can be measured via grain size distribution.

In a preferred embodiment, the filler consists of the non-water-reactive inorganic material.

Porous fillers can be used as non-water-reactive inorganic material.

As a non-water-reactive inorganic material, for example, calcite, silts, clays, quartz flour, fly ash, dusts or flours or mixtures thereof may be used.

In a preferred embodiment, the non-water-reactive inorganic material comprises or consists of calcium carbonate.

In a preferred embodiment, the non-water-reactive inorganic material comes from recycling processes, such as residues from crusher or processing plants.

In a preferred embodiment, the filler is used in the form of an aqueous suspension, which is mixed with the polymerization-curing reactive resin and dispersed therein. In this way, a homogeneous annular gap filling can be achieved.

In an advantageous embodiment, the polymerization-curing reactive resin is a reactive resin curing by polyaddition, polycondensation or by radical polymerization. A reactive resin based on acrylate or silicate resin or on polyurethane or on epoxy resin or polyester resin is particularly preferably used. Through the formulation of the components of the reactive resin, the curing behavior of the reactive resin can be adapted in a desired manner, on the one hand to ensure rapid curing in the annular gap and on the other hand to prevent premature curing during actual transport to the annular gap.

The composition may comprise 20% to 90% by volume of filler, preferably 40% to 70% by volume and more particularly 55% to 65% by volume of filler.

Furthermore, the composition may comprise 5% to 50% by volume of reactive resin, preferably 20% to 40% by volume and more particularly 35% to 35% by volume of reactive resin.

Furthermore, the composition may comprise 0.5% to 30% by volume of water, preferably 1% to 20% by volume and more particularly 5% to 15% by volume of water.

In an advantageous embodiment, the composition consists of reactive resin, non-water-reactive inorganic material and water.

In a preferred embodiment, the filler is mixed with the polymerization-curing reactive resin and dispersed therein, by conveying, after the combining of reactive resin and filler, these two components through a mixing device; preferably, the mixing device is a static mixer or a mechanical mixer. A static mixer has a conduit in the form of a pipe through which the components to be mixed are conveyed. There are flow-conducting elements in the pipe that divide and recombine the flow of material, thereby achieving mixing. A mechanical mixer comprises a stationary container in which a mixing tool, e.g., with propeller, screw or blades, rotates. Mechanical mixers in wide-spread use are colloidal mixers and dissolvers.

The invention is described below with reference to an exemplary embodiment in the drawings, in which:

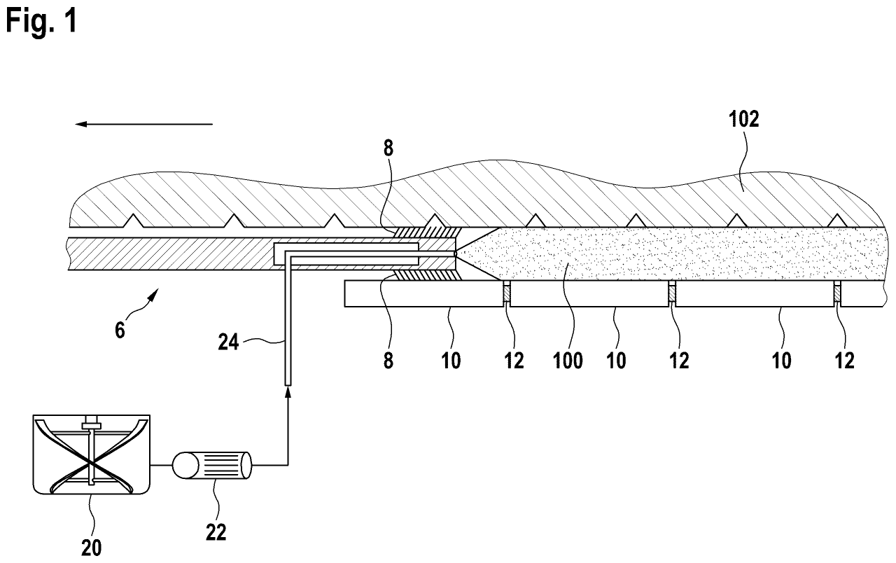

FIG. 1 shows a schematic detail view in section in the region of a shield tail of a tunnel boring machine, behind which segment components are successively inserted to form a segment tube,

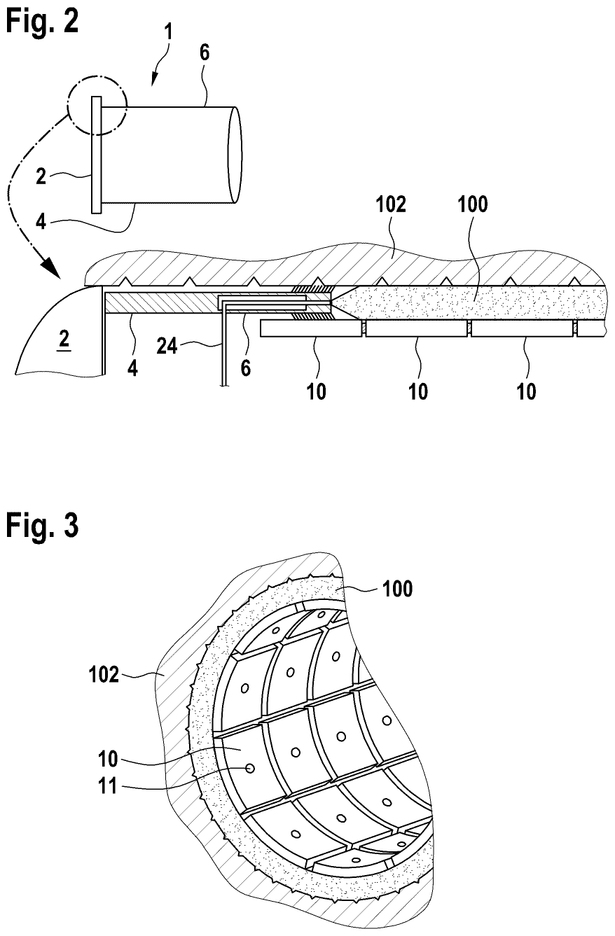

FIG. 2 shows a schematic lateral plan view of a tunnel boring machine with a front cutting wheel and a shield skin following it, and below in section a detail in the vertical upper end region of the tunnel boring machine and the bore with inserted segment components,

FIG. 3 shows a perspective view in cross section transverse to the longitudinal axis of the tunnel bore with installed segment components and a filling of an annular gap between the outer walls of the segment components and the bore in the rock mass,

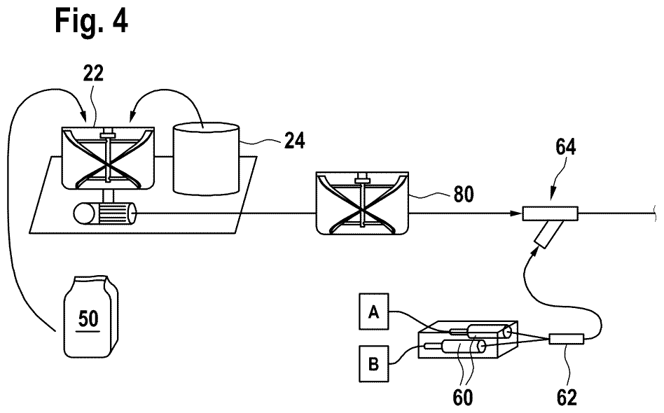

FIG. 4 shows a schematic representation of the preparation of the injection compound for filling the annular gap, where the filler is first mixed with water to form a suspension, which is then mixed in a mixer with reactive resin to form the injection compound intended for the filling of the annular gap.

The field of use of the method of the invention is now elucidated with reference to FIGS. 1 to 3. The bore in the subsurface is produced by a tunnel boring machine—in the exemplary embodiment shown, a shield machine 1—which is shown in simplified form in lateral plan view in FIG. 2 at the top. The shield machine 1 is provided at the front with a cutting wheel 2, followed behind by a shield skin 4, which is formed by a steel cylinder sleeve with a slightly smaller diameter in relation to the cutting wheel 2. The equipment and machines necessary for operation are accommodated in the shield skin 4; more particularly, the interior of the shield skin 4 accommodates drives, an advancement mechanism and devices for the installation of the segment components 10 made of concrete for forming the tunnel lining. The installation of the segment components 10 is carried out a few meters behind the cutting wheel 2, thus very quickly following the production of the respective bore section, with a robot-like device, the so-called erector (not shown), being employed for installing the segment components 10 in the rear part of the shield skin 4, the so-called shield tail 6. The tunnel boring machine is advanced by mechanical feed means which engage at the end face, i.e., at the frontmost ring of segment components of the tunnel lining and which advance the tunnel boring machine, supported there-on.

FIG. 1 shows a schematic sectional representation in the upper region of a bore just produced, where, of the tunnel boring machine, only an upper end region of the shield tail 6 and, of the tunnel lining, only an upper end region of the last-installed rings of segment components 10 are shown. As shown in FIG. 1, successive rings of segment components 10 are sealed by seals 12.

From the detail in the lower part of FIG. 2 it can be seen that the outer diameter of the cutting wheel 2 is slightly larger than the outer diameter of the following shield skin 4, which is why the bore in the surrounding rock mass has a slightly larger diameter than the shield skin 4. Furthermore, it can be seen from the detail view in the lower part of FIG. 2 that, since the segment components 10 are assembled at the rear inside the shield tail to form a respective ring, which then migrates out of the shield tail 4 to the rear when the tunnel boring machine advances, the outer diameter of the annular segment composed of the segment components is therefore still smaller than the diameter of the bore in the rock mass produced by the cutting wheel 2. Therefore, there remains a clearance between the outer casing of the tunnel lining formed by the segment components 10 and the inner wall of the bore in the rock mass produced by the cutting wheel 2. This interstice is called the annular gap. The annular gap must be filled with an injection compound, as explained in the introduction, in order to mount and embed the tunnel lining in the bore.

To produce the injection compound for the annular gap filling, reactive resin and filler are combined in a container of a mechanical mixer 20 inside the shield tail and are mixed by a mechanical mixer rotating in the container 20. The mixed injection material, driven by a pump 22, is then conveyed out of the mechanical mixer 20 and through a conduit. The injection material is fed into a conduit 24, which first leads radially outwards into the outer wall of the shield tail, there in a cavity of the shield tail 6 has a bend of 90° and in a further section runs parallel to the longitudinal axis of the cylindrical shield tail 6 to its end, where the conduit 24 opens to the annular gap. Several of these conduits 24 may be present, which are also present in conventional tunnel boring machines and are referred to as piles.

At the rear end of the shield tail 6, brush seals 8 are located both on the inner wall and on the outer wall, and firstly seal the end region of the shield tail 6 with respect to the outer wall of the last-formed ring of segment components 10 and secondly seal the outer wall of the shield tail 6 with respect to the surrounding rock mass. These brush seals 8 are intended to ensure that no injection material pressed from the end of the lip 24 into the annular gap beyond the filling of the annular gap is also pushed forward beyond the end region of the shield tail 6.

In this way, the injection material is pumped out of the container of the mechanical mixer 20 through the conduit leading from the container 20 by means of the pump 22 and further through the pile 24 into the annular gap, and so, as drilling by the tunnel boring machine progresses, in the resulting annular gap between the tunnel lining and the surrounding rock mass 102, an annular gap filling 100 is continuously formed. In this case, as a rule, several piles 24 are present, e.g., six piles distributed around the circumference of the shield tail 6, which convey injection material into the annular gap in a manner distributed around the circumference so as to fill this gap and, after curing of the annular gap filling 100, to form a stable bedding for the tunnel lining composed of the segment components 10.

In FIG. 3 it can be seen that the segment components 10 are each provided with an injection opening 11 passing through the segmenting component. These injection openings 11 are normally closed by seals. The injection openings 11 are used to fill any existing or newly formed cavities in the annular gap, after curing of the annular gap filling 100, by further injection of mixed reactive resin and filler.

In FIG. 4, an embodiment of the method of the invention is illustrated very schematically. In this case, the filler is formed by a mixture of water and non-water-reactive inorganic material. Here, the non-water-reactive inorganic material 50 (indicated schematically by a bag) is filled into the container 22 and mixed therein with water supplied from a water container 24, after which the mixture is pumped via a conduit into an aeration tank 80. In the aeration tank 80, the mixture is circulated by a rotating propeller. In parallel with this, two pumps 60 convey two monomer components A, B, which are combined downstream of the outlet of the pumps 60 and forced through a static mixer 62. From the outlet of the static mixer 62, the reactive resin is conveyed into an inlet of a static mixer 64. The static mixer 64 also has a second inlet for the conduit from the aeration tank 80, through which the filler suspension is supplied. In the mixer 64, the reactive resin and the filler suspension are mixed with each other, where for this purpose the mixer 64 can be embodied likewise as a static mixer. After mixing of filler suspension and reactive resin, the resulting mixture is conveyed further for injection into the annular gap—that is, in particular, into the piles 24, whose outlet openings at the end of the shield tail 6 open into the annular gap.

1. A method for the construction of a trafficway tunnel, a conduit shaft or a pressurized-water shaft by tubbing construction, wherein
segment components are assembled in a machine-generated bore in the rock or soil to form a closed lining in the form of a segment tube, and
the annular gap between the bore and the outer wall of the segment tube is filled with a composition which comprises polymerization-curing reactive resin and filler, where the filler, before or during conveying into the annular gap, is supplied with the polymerization-curing reactive resin, which is mixed with the filler and is dispersed therein,
wherein the composition is cement-free and the filler comprises a non-water-reactive inorganic material which has an average particle size≤500 μm.

2. The method as claimed in claim 1, wherein the non-water-reactive inorganic material has an average particle size of 0.5 to 300 μm.

3. The method as claimed in claim 1, wherein the filler consists of the non-water-reactive inorganic material.

4. The method as claimed in claim 1, wherein the non-water-reactive inorganic material comprises or consists of calcium carbonate.

5. The method as claimed in claim 1, wherein the non-water-reactive inorganic material is selected from calcite, silts, clays, quartz flour, fly ash, dusts or flours or mixtures thereof.

6. The method as claimed in claim 1, wherein the non-water-reactive inorganic material comes from a recycling process.

7. The method as claimed in claim 1, wherein the filler is used as an aqueous suspension.

8. The method as claimed in claim 1, wherein a reactive resin curing by polyaddition, polycondensation or by radical polymerization is used as the polymerization-curing reactive resin.

9. The method as claimed in claim 1, wherein a reactive resin based on acrylate or silicate resin or based on polyurethane or based on epoxy resin or polyester resin is used.

10. The method as claimed in claim 1, wherein the composition comprises 5% to 50% by volume of reactive resin.

11. The method as claimed in claim 1, wherein the composition comprises 20% to 90% by volume of filler.

12. The method as claimed in claim 1, wherein the composition consists of reactive resin, non-water-reactive inorganic material and water.

13. The method as claimed in claim 1, wherein the filler is admixed with the polymerization-curing reactive resin before the polymerization.

14. The method as claimed in claim 1, wherein the filler is mixed with the polymerization-curing reactive resin and dispersed therein, by mixing, after the combining of reactive resin and filler, the two components by a mixing device.

15. A method for filling an annular gap between a bore and an outer wall of a segment tube, comprising filling the annular gap with a composition which comprises polymerization-curing reactive resin and filler, the filler being cement-free and comprising a non-water-reactive inorganic material which has a particle size≤500 μm.
